(19) United States
(12) Patent Application Publication
(10) Pub. No.: US 2024/0036258 A1
(43) Pub. Date: Feb. 1, 2024

(54) FIBER EXIT ELEMENT

(71) Applicant: FIBERBRIDGE PHOTONICS GMBH, Hannover (DE)

(72) Inventor: Thomas THEEG, Seelze (DE)

(73) Assignee: FIBERBRIDGE PHOTONICS GMBH, Hannover (DE)

(21) Appl. No.: 18/257,642

(22) PCT Filed: Dec. 15, 2021
(86) PCT No.: PCT/EP2021/085988

§ 371 Date: Jun. 15, 2023

(30) Foreign Application Priority Data
Dec. 16, 2020 (DE) 10 2020 133 865.1

(51) Int. Cl. G02B 6/26; G02B 6/255

(52) U.S. Cl. CPC G02B 6/262; G02B 6/255

(57) ABSTRACT

The present invention relates to A fiber exit Element (1, 2) having A plurality of glass fibers (1), each having at least one core (11), which is each designed to guide A signal light radiation (A), and to at least one optical Element (2), preferably an optical window (2), an optical lens (2), an optical beam splitter (2), an optical prism (2) or an optical lens array (2), which is respectively connected and designed to receive the signal light radiation (A) from the open ends of the cores (11) of the glass fibers (1) and to discharge them as exit radiations via at least one exit surface (26), wherein the open ends of the cores (10) of the glass fibers (1), preferably further the open ends of the cores (10), are arranged within the material of the optical Element (2), preferably in relation to an entry surface (21) of the optical Element (2), and wherein at least the material of the open ends of the cores (11) of the glass fibers (1) is fused to the material of the optical Element (2). The fiber exit element (1, 2) is characterized in that the entrance surface (21) of the optical element (2) has at least one first depression (22a) and at least one first fused glass fiber (1a) and a second fused glass fiber (1b) are spaced apart from one another by the first depression (22a) of the entry surface (21).

The present invention relates to a fiber outlet Element according to claim 1, a fiber outlet Element according to claim 6, a fiber outlet Element according to claim 9, a fiber outlet Element according to claim 10, and an optical Element according to claim 15.

Nowadays, glass fibers are used in many different technical fields. The technical and particularly high-technical applications include the use of glass fibers for light transmission. Thus, glass fibers are used for data transmission by means of light; in this case, the glass fibers can also be referred to as optical waveguides or passive optical fibers. Glass fibers are also used in medicine for example for illumination and for producing images, for example in microscopes, in inspection cameras and in endoscopes. Furthermore, glass fibers are used in sensors which can then be referred to as fiber-optic sensors.

A further field of application for glass fibers is the laser technology. Here, the laser radiation can be guided as a signal light radiation by means of a passive optical fiber from a laser radiation source as a signal light source or as a signal light radiation source to a processing point in order to carry out, for example, cutting or welding there, for example in the material processing or in medicine. The laser beam can also be supplied as laser radiation in this way, for example, in measurement technology, in microscopy or in spectroscopy, for example a sample. The use of passive glass fibers for conducting a laser beam can take place, for example, in applications in mechanical engineering, in telecommunications, in medical technology and in sensor technology.

Glass fibers for generating or reinforcing laser light can also be used and referred to as active glass fibers. Fiber lasers for generating laser light or fiber amplifiers for amplifying laser light have, in sections, a doped fiber core (see below), which forms the active Medium of the fiber laser or of the fiber amplifier, i.e. its active optical fiber. Typical doping elements of the laser-active fiber core are in particular neodymium, ytterbium, erbium, thulium and Holmium. Fiber lasers or fiber amplifiers are used, inter alia, in the industry for ultrashort pulse laser systems (for example at a wavelength of about 1 μm), in measurement technology (for example in LIDAR measurements—laser detection and ranging), in medical applications (for example at a wavelength of about 2 μm) or in space applications (for example at a wavelength of about 1.5 μm).

Glass fibers which are used to amplify the signal light such as, for example, the laser radiation in fiber amplifiers or for generating laser radiation in fiber lasers usually have a fiber core, which consists of pure glass such as, for example, pure quartz glass and, in the case of passive glass fibers, is often doped with Germanium; in the case of active glass fibers, doping is usually carried out as described above. In certain cases, the fiber cladding can also be doped. This applies to passive and active glass fibers. Depending on the size and the numerical aperture of the fiber core, it is possible to distinguish between Single-Mode and Multi-Mode glass fibers. In addition, the fiber core can still have polarization-maintaining properties for the light and can therefore be referred to as polarization-maintaining optical fibers (PM). These can also be photonic crystal glass fibers and also Hollow Core glass fibers. Even if the main field of application relates to Glass Fibers, polymer Fibers or Fibers of other materials, for example so-called Soft Glass Fibers for the middle IR range, can likewise be used for such application (s).

The fiber core is usually surrounded radially from the outside by at least one fiber cladding, which is usually closed in the circumferential direction and thus completely surrounds the fiber core, apart from the two open ends of the optical fiber.

Usually, both passive glass fibers and active glass fibers are surrounded by a fiber coating of, for example, polymer comparable to the fiber cladding, which can then be added to the glass fiber. The fiber coating can serve to mechanically protect the glass interior of the glass fiber and influence the optical properties thereof. Usually, in the case of glass fibers in which the light is guided exclusively in the fiber core (Single-Clad glass fibers), the fiber coating primarily serves for mechanical protection. Glass fibers which guide light in the fiber core and in the fiber cladding (Double-Clad glass fibers) are usually designed with a fiber coating for fulfilling mechanical and optical properties.

Two cross-sectional shapes that occur frequently in practice for the fiber cladding are cylindrical and octagonal. The octagonal shape for the fiber cladding is used in particular in the case of active glass fibers.

Such glass fibers can be produced in large lengths and are usually available as roll products. The diameter of the fiber cladding typically varies between approximately 80 μm and approximately 1 mm. Particularly in the case of the larger fiber diameters, fiber rods are frequently already referred to in practice.

For a fiber amplifier, four essential passive fiber components are typically necessary: a signal light radiation input as an interface for the feed-in or for the coupling of the signal light radiation to be amplified as input radiation from outside the fiber amplifier, a pump light coupler, which transports the pump light radiation virtually loss-free from the pump light source into the sheath of the active optical fiber, a pump light trap which receives non-absorbed pump light from the active optical fiber or removes it from the sheath of the optical fiber, and a signal light radiation output which forms and/or guides the output radiation and thereby couples and provides the output radiation to outside the fiber amplifier. The signal light radiation output can also be referred to as fiber exit element or as fiber exit optics.

In the case of a fiber laser, a pump light coupler, an active glass fiber, a pump light trap and a signal light radiation output are usually also used. Since no signal light radiation is supplied from outside, but the laser radiation within the fiber resonator is generated between two reflectors or mirror elements, the signal light radiation input is omitted.

In any case, an optical window with a one-sided anti-reflection coating for the corresponding wavelengths or a lens for collimating the output radiation can serve as the signal light radiation output or as a fiber exit element. The fiber exit optics can also be a further glass fiber which guides the output radiation to a destination. Such fiber exit optics are usually bonded to the open end of the glass fiber, for example by welding, also known as splicing. As a result, the signal light or the laser light can transition directly into the fiber exit optical system, for example as an optical window or as a lens, and exit from there to outside, for example, the fiber amplifier or fiber laser. By means of the optical window or by means of the lens, the beam of the signal light or of the laser light can thereby be expanded, i.e. increase its cross section and thereby reduce its power density, which can be favorable or necessary for certain applications.

It is thus known to connect a single glass fiber to a single fiber outlet element by material bonding, as described above. However, for many applications, for example in the processing of materials or in medical technology, it is relevant to use a plurality of laser beams in a very spatially compact and especially thermally and mechanically highly stable arrangement at the place of use. This could be realized, for example, in the free beam optics with any arrangement of microlenses, but this would lose the considerable advantages of glass fiber technology.

If instead a plurality of glass fibers each with a single fiber exit element are combined with one another, this leads to an additional effort in order to arrange and align the fiber outlet elements with respect to one another, so that the respective signal light beams can emerge and be used as desired to one another. This at the same time represents a significant source of error during assembly, which can lead to a poor or even unusable end product. This also increases the installation space of the end product at least in the region of the fiber outlet elements. Furthermore, certain minimum distances of the individual glass fibers from one another cannot be avoided, which are due to the size of the respective fiber outlet elements which are arranged parallel to one another and together form the actual fiber exit element.

U.S. Pat. No. 6,819,858 B2 describes a shaped non-crystalline polymer material holder configured to have a channel for holding a silicon Chip with a plurality of adjacent V-shaped grooves formed in an upper surface between right and left side portions thereof, wherein a recessed region in the channel is provided behind the Chip for receiving a fiber buffer coating, and a notch is formed in an upper portion of the holder between the channel and a side portion thereof to hold reinforcing fibers of an optical fiber cable, wherein the V-groove is configured to receive individual optical fibers therein in each case. Two such shaped holders with silicon Chips are securely layered with the V-shaped groove of the Chips opposing each other to hold the optical fibers therebetween.

U.S. Pat. No. 6,978,073 B2 describes an optical fiber array comprising an alignment substrate, a plurality of ferrule elements and a plurality of optical fibers. The alignment substrate has a plurality of guide holes arranged two-dimensionally and extending through the substrate. The Ferrule is inserted in the same direction into the guide holes and has through holes in the central sections. The optical fibers are fitted and held in the respective through holes. The guide hole is shaped into a cylindrical shape, the diameter of which substantially corresponds to the outer diameter of the Ferrule. The light entry/exit end face of the optical fiber is exposed on an end face of the Ferrule.

A disadvantage of the two previously described documents is their mechanically form-fitting and or force-fitting hold of the individual glass fibers, which can be regarded as less stable, defined and or long-lasting compared to the previously described integral welding or splicing. As a result of the mechanical forces of these connections, mechanical stresses within the held glass fibers can also be generated, which can influence the optical transmission behavior of the glass fibers. This can take place in particular undefined and act in a disturbing manner on the signal light transmission.

Another disadvantage of this is that in this procedure the free ends of the glass fibers, which form the interface between the material of the glass fiber, such as glass and the environment such as, for example, air, can easily be damaged or destroyed during the transmission of average and high optical powers of a few watts to several Kilo-watts.

US 2012/045169 A1 describes a method and apparatus for forming an optical fiber Array assembly, comprising: providing a plurality of optical fibers including a first optical fiber and a second optical fiber, providing a fiber Array plate comprising a first surface and a second surface, connecting the plurality of optical fibers to the first surface of the fiber Array plate, transmitting a plurality of optical signals through the optical fibers into the fiber Array plate at the first surface of the fiber Array plate, and emitting a composite output beam with light from the plurality of optical signals from the second surface of the fiber Array plate. In some implementations, the plurality of optical fibers is butt welded to the first surface of the fiber assembly plate.

A disadvantage of the connection of the open end of at least one glass fiber with an optical Element of a fiber exit optical system is that material can pass between the open end of the glass fiber and the entry surface of the optical Element both when gluing by means of an additional adhesive and when fusing or welding the materials of the optical fiber and the optical Element. This can lead to disturbances in the coupling or transmission of the signal light radiation from the core of the optical fiber into the optical Element at its entry surface.

If, in order to avoid these disadvantages, the open end is placed on the entry surface of the optical Element in a blunt manner and is bonded to one another at the edge by gluing by means of an additional adhesive or by fusing or welding the materials of the optical fiber and the optical Element, only a comparatively mechanically weak connection between the open end of the optical fiber and the optical Element at the entry surface thereof can be achieved.

The orientation of the open end of the glass fiber with respect to the entry surface of the optical Element can also change with uneven adhesive bonding or welding against the blunt, i.e. vertical, placement, which accordingly affects the propagation of the signal light of the optical fiber through the optical Element and even leads to unusable component.

Another disadvantage is that the entry surface and further surfaces of the optical element can be optically roughened except for the exit surface thereof. This may serve to extract or diffusely reflect interference light radiation in the optical Element, for example from the sheath of the optical fibers or reflected signal light radiation from the optical Element exit surface of the optical Element. The reduction of such interference light radiation can be absolutely necessary in particular in the case of higher optical powers for the feasibility of the respective application or the reduction of the susceptibility of the laser system to malfunction. If the open end of the glass fiber is placed on an entry surface that is optically roughened in such a way, and integrally bonded there at the edge side, the transition of the signal light radiation from the core of the glass fiber into the optical Element can also be impaired by the roughened surface. The impairments can have a significant effect on the signal transmission at the junction, the beam quality or the polarization of the signal light radiation, for example. In the case of medium and high optical powers, the entire optical element can even be destroyed as a fiber arrangement (fiber array plate) and the bonded laser systems. Therefore, if the roughened entry surface is dispensed with, the advantages of a roughened surface can not be used at least in the case of the entry surface of the optical element.

WO 2020/254661 A1 describes a fiber exit Element having a plurality of glass fibers, each having at least one core, which is each designed to guide a signal light radiation, and to at least one optical Element which is connected to an open end of the cores of the optical fibers in each case and is designed to obtain the signal light radiation from the open ends of the cores of the glass fibers and to discharge them to the outside as exit radiation via at least one exit surface. The open ends of the cores of the glass fibers are each arranged with a penetration depth within the material of the optical element, wherein at least the material of the open ends of the cores of the glass fibers is fused to the material of the optical element.

The production of the fiber exit element takes place in that, in a processing zone of the optical element, where the open end of the cores of the glass fibers is to be inserted with the penetration depth into the material of the optical element, the material of the entry surface of the optical element is heated correspondingly strongly and is thereby melted, for example by means of a laser beam.

If a plurality of glass fibers arranged next to one another are connected in succession to the optical Element in this manner, in particular in the case of a serial, i.e. temporally offset, connection of the glass fibers, the entry of the thermal energy for melting the material of the optical Element of a further glass fiber can damage or destroy the glass fiber which has already been fused beforehand with the optical Element and is arranged sufficiently close to the glass fiber which is now to be fused to be reached by the thermal energy introduced into the optical Element for this purpose. This risk exists in the case of any further glass fiber to be introduced for at least one correspondingly close-up glass fiber. This can render the already fused glass fiber and thus also the fiber exit element unusable.

It is an object of the present invention to improve the possibilities for producing a fiber outlet element described at the outset. In particular, the glass fibers or glass fiber packages, which are in particular joined in succession, can be better thermally protected during fusing with the optical Element. This is to be possible as simple and or cost-effective as possible. In particular, this should be possible without changing the joining process of glass fibers and optical Element. At least one Alternative to the known manufacturing possibilities is to be provided.

The object is achieved according to the invention by a plurality of fiber outlet elements and by an optical Element with the features of the independent claims. Advantageous developments are described in the dependent claims.

Thus, the present invention relates to a fiber exit Element having a plurality of glass fibers each having at least one core, each of which is designed to guide a signal light radiation, and to at least one optical Element, preferably an optical window, an optical lens, an optical beam splitter, an optical prism or an optical lens array, which is respectively connected to an open end of the cores of the optical fibers and is designed to dispense the signal light radiation from the open ends of the cores of the optical fibers and to discharge them as exit radiations via at least one exit surface, wherein the open ends of the cores of the glass fibers, preferably further the open ends of the glass fibers, are arranged in each case with a penetration depth, preferably opposite an entry surface of the optical Element, within the material of the optical Element, and wherein at least the material of the open ends of the glass fibers, preferably further the material of the open ends of the shells of the glass fibers, is fused to the material of the optical Element.

The fiber exit element according to the invention is characterized in that the entry surface of the optical element has at least one first depression and at least one first fused glass fiber and a second fused glass fiber are spaced apart from one another by the first depression of the entry surface. A plurality of first glass fibers can also be used as the first glass fiber package and a plurality of second glass fibers as the second glass fiber packet. In any case, thermal decoupling of the two glass fibers or glass fiber packages during production, i.e. during the melting of the respective processing zone for the manufacturing process between optical Element and glass fiber, can take place, since the heat of the processing zone of the second optical fiber can not reach or only to a sufficiently small extent in order to avoid damage to the first glass fiber in the continuous manufacturing process. This can improve the production quality of the fiber exit element or reduce the quality of insufficient fiber exit elements or even allow the technical implementation of a certain arrangement of glass fibers at all. This can reduce the production costs in each case.

The recess extends from the entry surface of the optical element at least substantially and preferably exactly in the direction of extension of the optical fibers into the material of the optical element. The depression can have been introduced into the material of the optical element by removing material, for example by sawing, milling, etching, laser or the like. This can preferably take place during the production of the optical element or during the preparation of the joining, preferably by means of the same processing apparatus.

In this case, the depression can have any desired shape or contour which is suitable for achieving the desired thermal insulation between the glass fibers or the glass fiber packets.

According to one aspect of the invention, the first depression of the entry surface is designed in a linear manner and the fused glass fibers are arranged perpendicular to the linear extension of the first depression of the entry surface. This can enable a particularly effective thermal decoupling with comparatively little intervention in the structure of the optical element or its entry surface.

According to a further aspect of the invention, at least the first fused optical fiber is enclosed by the first depression or by a plurality of, preferably cross-linear, depressions. This can enable thermal decoupling around the first fused glass fiber so that the spread of heat from the processing zone in all directions of the entry surface, i.e. horizontally, can be prevented or at least reduced.

According to a further aspect of the invention, the entry surface of the optical element has a plurality of, preferably linear, depressions and a plurality of fused glass fibers are each spaced apart from one another by one of the depressions of the entry surface. This can make it possible to apply the above-described aspects according to the invention to correspondingly many glass fibers during their fusing in the material of the entry surface of the optical element.

Preferably, the fused glass fibers are each arranged perpendicular to the linear extension of the depressions of the entry surface. As a result, the corresponding aspects described above can be transferred to several fused glass fibers.

Preferably, the fused glass fibers are each surrounded by one of the depressions or a plurality of, preferably cross-linear, depressions. As a result, the corresponding aspects described above can be transferred to several fused glass fibers.

According to a further aspect of the invention, the first depression of the entry surface is arranged annularly around the first fused glass fiber. This can increase the freedom of design. A targeted thermal insulation of the first glass fiber in the plane perpendicular to the elongate extension of the first glass fiber can also thereby take place.

The present invention also relates to a fiber exit Element having a plurality of glass fibers each having at least one core, each of which is designed to guide a signal light radiation, and to at least one optical Element, preferably an optical window, an optical lens, an optical beam splitter, an optical prism or an optical lens array, which is connected to an open end of the cores of the optical fibers in each case and is designed to dispense the signal light radiation from the open ends of the cores of the optical fibers and to discharge them as exit radiations via at least one exit surface, wherein the open ends of the cores of the glass fibers, preferably further the open ends of the glass fibers, are arranged in each case with a penetration depth, preferably opposite an entry surface of the optical Element, within the material of the optical Element, and wherein at least the material of the open ends of the glass fibers, preferably further the material of the open ends of the shells of the glass fibers, is fused to the material of the optical Element.

The fiber exit element according to the invention is characterized in that the entry surface of the optical element has at least one first elevation, wherein at least one first fused glass fiber is arranged in the first elevation of the entry surface and at least one second fused glass fiber is not arranged in the first elevation of the entry surface of the first optical fiber. The second fused glass fiber can thus be arranged on the entry surface of the optical element itself or on a second elevation of the entry surface.

Therefore, the approach according to the invention can also convert a thermal influence on a first already fused glass fiber by fusing a second glass fiber, in particular directly adjacent, in the material of the entry surface of the same optical element in that at least one first elevation is applied to the entry surface of the optical element by material application in order to thereby raise the processing zone during fusing of a glass fiber with respect to the entry surface of the optical element and also to thermally insulate it laterally, i.e. horizontally, in this way. The material application can take place, for example, via additive methods such as 3D printing.

According to one aspect of the invention, the second fused optical fiber is arranged in a second elevation of the entry surface. As a result, the above-described aspects of the invention can also be transmitted to the second fused glass fiber or applied there.

According to a further aspect of the invention, the first elevation, preferably and the second elevation, of the entry surface are formed in a linear or punctiform manner. As a result, the first elevation can be specifically implemented as described above. This can be carried out in a linear manner, if necessary, to simplify the application of material. This can be carried out in a punctiform manner in all directions in the horizontal and the processing zone or around the elevation. The expense of the material application can also be kept low.

The present invention further relates to a fiber exit Element having a plurality of glass fibers each having at least one core, each of which is designed to guide a signal light radiation, and to at least one optical Element, preferably an optical window, an optical lens, an optical beam splitter, an optical prism or an optical lens array, which is connected to an open end of the cores of the optical fibers in each case and is designed to dispense the signal light radiation from the open ends of the cores of the optical fibers and to discharge them as exit radiations via at least one exit surface, wherein the open ends of the cores of the glass fibers, preferably further the open ends of the glass fibers, are arranged in each case with a penetration depth, preferably opposite an entry surface of the optical Element, within the material of the optical Element, and wherein at least the material of the open ends of the glass fibers, preferably further the material of the open ends of the shells of the glass fibers, is fused to the material of the optical Element.

The fiber exit element according to the invention is characterized in that at least one first fused glass fiber and a second fused glass fiber are spaced apart from one another by at least one spacer element, preferably as glass fiber, more preferably as a core-less glass fiber.

The spacer element can in particular be a piece of a glass fiber and very particularly a piece of a core-less glass fiber which has only the material of the sheath, so that the same or comparable materials can be used or combined with one another. However, the terminating element can also be formed from any other suitable material.

After the glass fibers have been fused, the spacer element can be removed again or remain there. In the latter case, the spacer Element can be fused together with the optical fiber into the optical Element.

In any case, prior to the, preferably common, fusing of the glass fibers in the entry surface of the optical element, a spacing or positioning of the glass fibers to be fused relative to one another can thereby take place, which increase the accuracy of the positioning, enable the flexible adjustment of the fiber-to-fiber distance and/or can also cause a certain thermal insulation and/or a certain mechanical stability during fusing to one another.

The present invention further relates to a fiber exit Element having a plurality of glass fibers each having at least one core, each of which is designed to guide a signal light radiation, and to at least one optical Element, preferably an optical window, an optical lens, an optical beam splitter, an optical prism or an optical lens array, which is connected to an open end of the cores of the optical fibers in each case and is designed to obtain the signal light radiation from the open ends of the cores of the glass fibers and to discharge them to the outside as exit radiation via at least one exit surface.

The fiber exit element according to the invention is characterized in that the open ends of the cores of the glass fibers, preferably further the open ends of the shells of the glass fibers, are each integrally bonded, preferably fused, to a first open end of a transition element, wherein the second open ends of the transition Elements are each arranged with a penetration depth, preferably opposite an entry surface of the optical element, within the material of the optical element, and wherein at least the material of the second open ends of the transition Elements is fused to the material of the optical element.

By means of the transmission element, a transmission or a line of the signal light radiation from the first optical fiber to the entry surface of the optical element can thus be effected on the one hand. On the other hand, the first optical fiber and the entry surface of the optical element can be indirectly connected by means of the transmission element, so that the fusing in the entry surface of the optical element takes place by means of the transmission element and not by means of the first optical fiber. As a result, the first glass fiber can also be thermally protected and, if necessary, improved optical and or mechanical properties can be achieved.

Preferably, the transition elements are transition fibers which each have a core and or a sheath, preferably a sheath substantially enclosing the core. Thus, fiber cores, coreless fiber jackets and/or fiber cores with fiber jackets can be used as transition fibers. This can take place in each case alone or in mixed form. This can simplify the implementation and/or promote the transmission of the signal light radiation.

The transition fibers preferably have cores which have the same diameter as the cores of the glass fibers. Preferably, the cores of the transition fibers have the same numerical aperture as the cores of the glass fibers. Alternatively or additionally, the transition fibers then preferably have a different fiber sheath diameter, i.e. preferably a larger or smaller fiber sheath diameter than the jackets of the glass fibers. In addition, a mode rim adapter can be realized at the transition from the glass fibers to the transition fibers to maintain signal properties.

According to a further aspect of the invention, the transition elements are formed, at least in sections, preferably completely, wider than the glass fibers, wherein the transition elements preferably rest against one another at least in sections, preferably completely. As a result, the transmission elements can simultaneously serve as a spacer element, as already described above.

According to a further aspect of the invention, the entry surface is arranged at an angle to the exit surface and or the entry surface has at least two sections which are arranged at an angle to one another and or to the exit surface. This can increase the freedom of design of the fiber exit element.

According to a further aspect of the invention, the exit surface of the optical element has, at least in sections, preferably over the entire surface, an optical coating, preferably an optical Anti-reflection coating. As a result, the transition of radiation through the exit surface out of the optical Element and/or from the side of the exit surface into the optical Element can be influenced. In particular, the penetration of interference radiation from outside the optical element can be prevented or at least reduced by an optical Anti-reflection coating. Such a coating can be selected accordingly in order to reflect the relevant wavelengths or wavelength ranges. This may reduce the amount of interference radiation within the optical element.

According to a further aspect of the invention, at least one, preferably some, particularly preferably all, of the glass fibers has at least one sheath which substantially encloses the core, wherein at least one pump light trap, preferably as depressions, in the material of the sheath of the glass fiber is formed in the region of the fiber outlet element in order to dissipate cladding light from the sheath of the glass fiber to outside the optical fiber. Such a pump Light trap can also be referred to as Cladding Light scraper or as Cladding Light Stripper. As a result, disruptive cladding light can be removed directly in front of the optical Element from the men of the glass fibers and/or reduced or returned cladding light from the optical Element. This can reduce the entry of interference radiation into the optical Element.

According to a further aspect of the invention, at least the entry surface of the optical element, preferably all outer surfaces of the optical element, apart from the exit surface of the optical element, are optically roughened and at least the exit surface of the optical element, preferably exactly the exit surface of the optical element, is formed with optically smooth surface quality. An optically roughened surface can take place, for example, by means of a machining with a mechanical tool such as, for example, by grinding, but also by means of a laser beam as a tool. An optically smooth surface can also take place by means of machining with a mechanical tool such as, for example, by polishing, but also by means of a laser beam as a tool. An optically smooth surface quality is given if, at the corresponding wavelength or in the corresponding wavelength range of the signal light radiation, the necessary optical properties can be largely obtained during the exit via the exit surface for the respective application or a corresponding optical coating can be applied properly. Often, the Scratch-Digit specification of the standard MI L-PRF-13830 B is used, inter alia, to evaluate the surface quality.

An optically roughened surface of the optical Element can be advantageous for its outer surfaces except for the exit surface in order to allow interference radiation out of the optical Element and thereby reduce the volume of the optical Element. Such an interference light can be cladding light from the sheath of the glass fibers. It can also lead to reflection of the signal radiation at the side surfaces of the optical element. In addition, signal light radiation in the optical Element can be partially reflected in the form of interference light at the exit surface. Furthermore, signal light radiation can again pass into the optical Element by reflection from the outside, for example from the machining or application location of the signal light radiation. In order to reduce the named interference light radiation in the optical Element and thus to ensure a safe operating state, an optically roughened surface can be advantageous as already mentioned.

According to a further aspect of the invention, at least some, preferably all, of the open ends of the cores of the glass fibers, preferably further the open ends of the cores, are arranged in each case with the same penetration depth or with a different penetration depth within the material of the optical element. The use of the same penetration depth can simplify production. By varying the penetration depth between individual glass fibers, the exit radiations or an exit beam combined therefrom can be influenced in its optical properties. In other words, due to their different penetration depth into the optical Element, the signal light radiations of the individual glass fibers can pass through optical paths of different length therein and thus have different optical properties, such as different beam diameters, at the exit surface of the optical Element.

According to a further aspect of the invention, at least some, preferably all, of the cores of the glass fibers, preferably and/or some, preferably all jackets of the glass fibers that are substantially enclosing the cores, have a constant or different diameter and/or a constant or different cross section at least in the region of the fiber exit element in their longitudinal direction of extension. This can increase the design possibilities of the output radiations.

In this case, by etching before the welding process, the diameters of the glass fibers or their jackets can be reduced in a targeted manner, so that, for example, the cores of the glass fibers in the optical Element can be brought spatially closer to one another. The diameters of the individual glass fibers can also be reduced by tampering, which can also lead to the above-described geometric advantages. In addition, the mode field diameter of the signal before the welding process can still be modified during the day in order to achieve desired properties of the combined exit beam.

According to a further aspect of the invention, at least some, preferably all, of the cores of the glass fibers, preferably and/or some, preferably all jackets of the glass fibers that are substantially enclosing the cores, have the same or different materials and or the same or different diameters and or the same or different cross sections, preferably circular, rectangular, square or octagonal. It is preferably also encompassed by the fact that Single-Mode glass fibers, large-Mode Area glass fibers, multi-Mode glass fibers, polarization-maintaining glass fibers, photonic crystal glass fibers and multicore glass fibers can be used. This can increase the design possibilities of the output radiations.

The present invention also relates to an optical Element for use in a fiber exit Element as described above. As a result, an optical Element as described above can be provided in order to be able to produce the fiber exit Element according to the invention.

In other words, the present invention relates to an optical component and a production method for compact combining and shaping of light with optical glass fibers.

Optical glass fibers are nowadays typically used to generate Laser radiation or to Transport Laser radiation from the Laser to the site of use. These can be, for example, single-Mode or Multi-Mode glass fibers, polarization-maintaining glass fibers (PM) or photonic crystal glass fibers as well as Hollow Core glass fibers in order to name only a few examples of commercially available glass fiber types. The optical components and methods for producing these components shown in the following therefore refer to the full range of the commercially available glass fiber types. Even if the main field of application relates to Glass Fibers, polymer Fibers or Fibers of other materials, e.g. so-called Soft Glass Fibers for the middle IR range, can likewise be used for this application (s).

However, for many applications, for example in material processing, medical technology, telecommunication of the measurement technology, it is relevant to use a plurality of laser beams in a very spatially compact and especially thermally and mechanically highly stable arrangement at the place of use. Furthermore, due to the limitation of the optical output power of laser systems, it is desirable to physically or incoherently superimpose the laser radiation from individual laser systems. This could be realized, for example, in the free jet optics with any arrangement of separate or bonded glass fibers with microlenses, but the use of free beam optics would lose the considerable advantages of glass fiber technology, e.g. mechanical and thermal stability.

In order to overcome this problem, a plurality of glass fibers can be welded in any arrangement to an optical Element (spliced, Fusion Splicing), see, for example, WO 2020/254661 A1. As a result, a one- or two-dimensional fiber array can be realized. By means of the welding (splicing), a monolithic optical component is realized, which is particularly suitable for medium and high optical powers and at the same time enables a glass fiber-based light conduction and shaping (usually spatially) of energy radiation in a compact form, preferably laser radiation in a rough industrial environment or in a region with high safety aspects, such as in medical technology, or in a field of application with extremely high temperature requirements or the coherent and incoherent combination of laser radiation. In addition to the typical welding, other connection techniques could also be used. The optical Element can be a glass block, an optical window, a lens, a silicon chip with optical waveguides or any other optical Element which can be used for optical beam guidance in different wavelength ranges and or optical power classes.

When joining the glass fibers to the optical Element, the optical fiber is connected to the optical Element with a certain penetration depth relative to the entry surface of the optical Element, for example by a welding process, see, for example, WO 2020/254661 A1.

If the glass fibers are joined to the optical Element with a low fiber-to-fiber distance, then there is the possibility that the high welding temperatures—in the case of quartz glass in the region of 2000° C., already damage adjacent glass fibers. This means that during welding, the process zone has such a large spatial extent in the optical Element, so that damage to other (adjacent) glass fibers can occur.

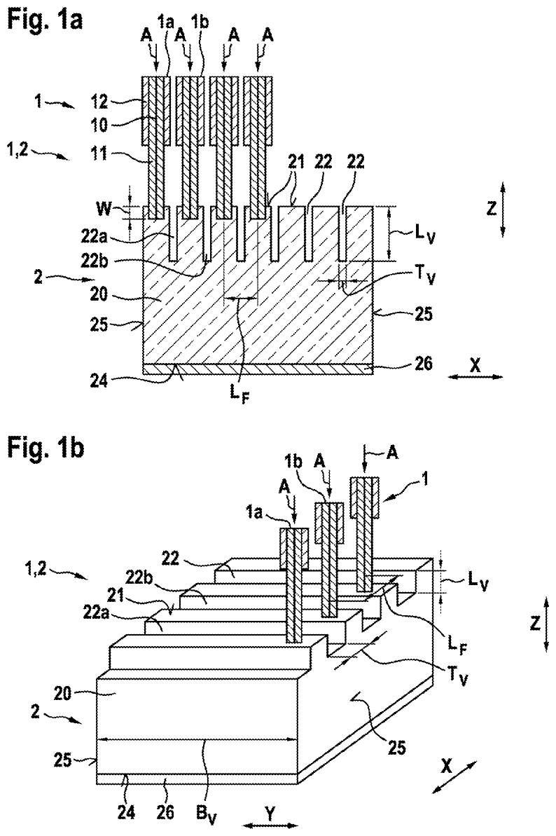

In order to minimize these thermal damage, depressions (see FIGS. 1a to 1c) can be introduced between the glass fibers or webs (see FIG. 1d) can be applied, which prevent the heat flow or the propagation of the energy in the optical Element at least in the region close to the surface.

The depressions can be designed in any shape, in parallel, trapezoidal, gaussian or at 2-dimensional fiber arrays, for example in the form of holes or rings. In practice, the exact shape of the recesses or webs is typically dependent on the use of the respective tool for carrying out the depressions or webs. A saw, a Laser or an etching process can be used as a tool for introducing depressions, for example. The application of webs can be realized, for example, by additive manufacturing, for example with a glass-based 3D printing. In this case, the webs can be designed very flexibly due to the structure, the geometry and the choice of material. The depressions can also be filled with any material in terms of process engineering. An air flow can also be guided through the depression in order to control the cooling process in a more targeted manner during the joining process. The length of the depression and the width of the recess can be selected as desired depending on the structure of the fiber array in order to achieve the corresponding thermal insulation. The depressions and the width of the depressions can be identical or different within an optical component. The recesses and width of the recesses may typically vary in the range of a few microns to a few millimeters. Identical or different glass fibers can be connected to an optical Element (fiber type, diameter, . . . ). The fiber-to-fiber distance can be the same or different for an optical Element or may optionally have a Gradient, for example from left to right or from the center to the outside.

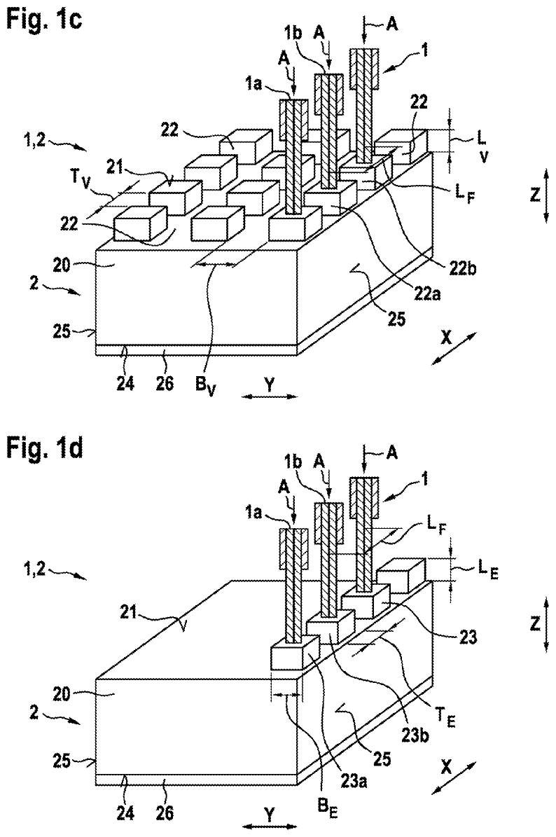

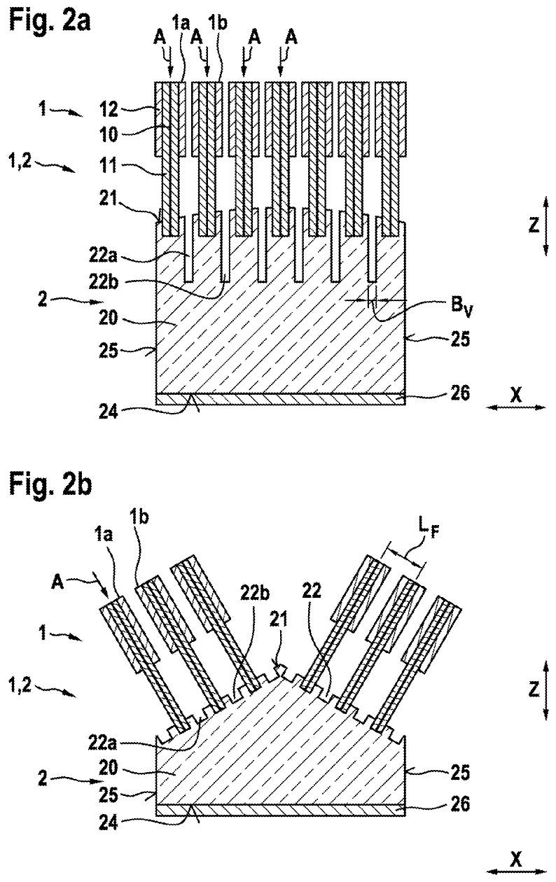

FIGS. 1a to 1c show the potential structure of a 2-dimensional fiber array with depressions and FIG. 1d with webs in order to thermally insulate the individual fiber rows from one another during the joining process. Along the individual webs, depressions can likewise be introduced between the glass fibers (not shown). Further exemplary embodiments are apparent from FIGS. 2a, 2b and 3. As a result of their nature, in addition to the thermal insulation, the depressions and webs can also exert an (I) thermal, (II) mechanical and (III) optical function during operation of the fiber array, for example (I) cooling on the welded connection during the Transport of high optical powers through the fiber array, (II) increase in the mechanical stability of the welded connection between the glass fiber and the optical Element and (III) influencing the optical beam propagation properties in the fiber array. In special cases, it may also be expedient to connect the glass fibers in the depressions to the optical Element and to use the webs as protection in the joining process.

In addition, individual glass fibers or all glass fibers can be connected to the optical Element at a certain angle to the entry surface. Laser beam sources or other beam sources (coherent or incoherent, possibly polarization-maintaining, possibly pulsed) can be connected to the glass fibers. The electromagnetic radiation can thus be transported from a plurality of laser beam sources or other beam sources to the place of use.

In this case, the beam sources or the power components in the optical fibers can be operated simultaneously, offset in time or with a temporal Modulation of the individual power components in the optical fibers that is meaningful for the process. The beam sources can be structurally identical or differ, for example, in the polarization, in the wavelength or in the optical pulse length. It is also possible to transmit the power or individual spectral power components of a beam source or possibly laser beam source to the glass fibers in any division ratios. The Laser or any other light source can operate continuously or in a pulsed manner. The glass fibers can also be used for coherent or incoherent combination of laser beam sources.

Depending on the application, there are numerous possibilities for variation based on the available properties of the laser systems or other available light sources. The optical Element can be, for example, an optical window with or without an optical coating or a lens as well as an optical beam splitter or a microlens array in order to name only a few examples of optical elements. The optical Element can also consist of a plurality of optical individual elements, for example an Array of microlenses or a flexible material (e.g. Polymer) with usable optical properties for the respective application. The optical Element can also consist of different materials or vary into its material properties over its Dimension (x, y and z direction), for example by partial doping of the optical Element. If the optical Element is composed of different materials, these can be glued, welded or bonded.

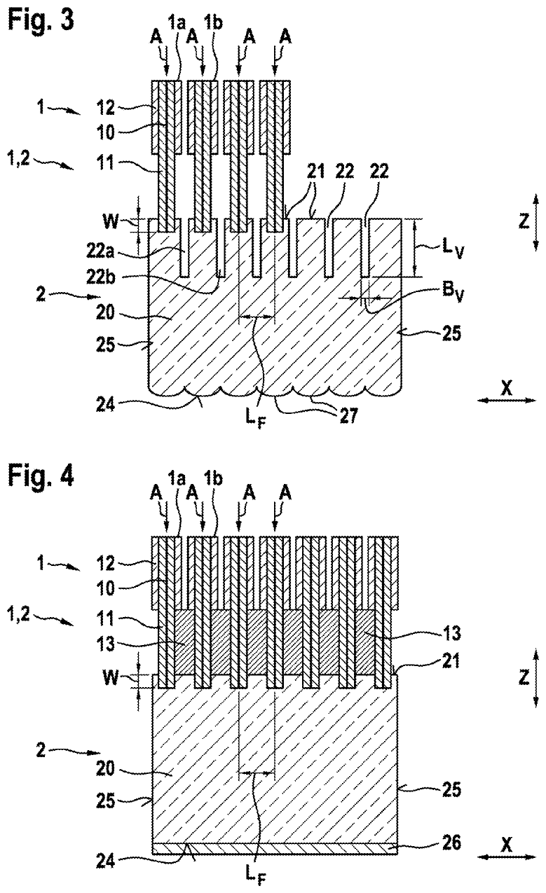

If glass fibers with a certain fiber-to-fiber are connected to an optical Element (joining process), in a uniform, different or e.g. gradual distance, precise spacers (spacers) can be used to adjust the fiber-to-fiber distance between the glass fibers (see FIG. 4). The spacers may be glass fibers or any other bodies with any desired shapes and any materials. Typically, the spacers extend over a length range of a few 10 mm along the fiber cladding, but can also be used only in certain regions in order to adjust the distance of the glass fibers. The spacers can, for example, also be wedge-shaped in order to position the glass fibers at a certain angle to one another. Typically, the spacers are positioned between the sheath of the glass fibers. However, the Spacer can also be placed between the coating of the fibers, for example. The spacers may optionally be welded in the optical Element, as shown in FIG. 4.

In addition to the setting of the fiber-to-fiber distance, the Spacer can also perform optical functions, for example act as Cladding Light Stripper or control thermal process at medium and high optical powers (e.g. cooling). The Spacer can also improve the mechanical stability of the fiber array assembly. Typically, the spacers for setting fiber-to-fiber are used in the range of a few 10 micrometers up to a few millimeters. In FIG. 4, the spacers between the glass fibers are formed as individual pieces. It is also expedient to form the spacers as a, for example, sheet-like Element (from one piece) that, for example, grooves or V-grommets for positioning the glass fibers have and are first connected to the optical Element, optionally also welded or printed (additive manufacturing), and then serves as a Spacer and support Element for the glass fibers.

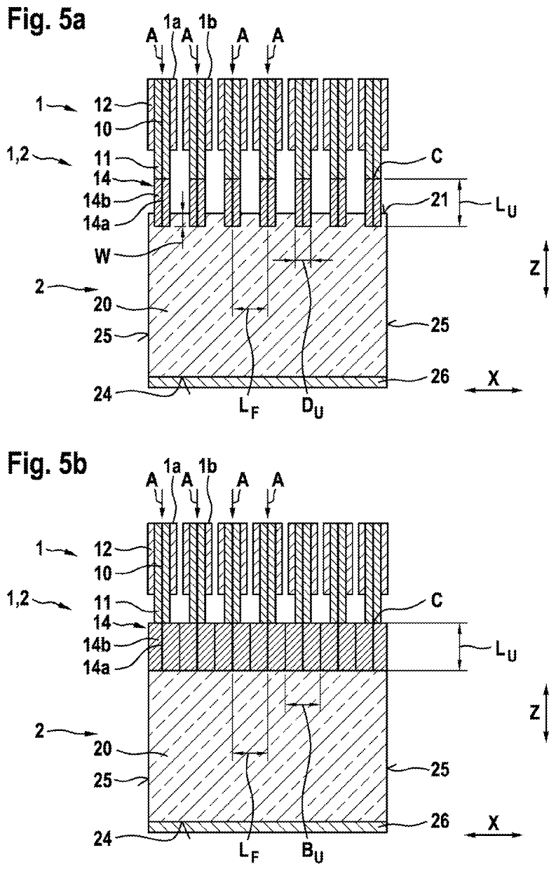

For improving or optimizing the mechanical, thermal or optical properties of the fiber array element, transition fibers can be used (see FIGS. and 5b). In addition, the transition fibers can be used for process engineering reasons, for example for improving the joining process or for better positioning of the glass fibers before or during joining, for example by the transition fibers acting simultaneously as spacers (spacers). The transition fibers are connected to the optical Element, for example welded (see FIGS. 5a and 5b). The transition fibers are bonded to the glass fibers of the fiber array, for example by splicing. Depending on the design of the transition fiber, other joining processes are also possible. The transition fibers can be designed for improving the properties listed for the fiber array element and/or the manufacturing process from different materials and in different forms.

It should also be expressly mentioned here that the term transition fiber is not exclusively related to fibers. The transition fiber can also be defined as a transition element. The transition fiber (also transition element) can control the optical properties of the light or the laser radiation passively or actively, depending on the choice of transition fiber or the transition element (material, shape, optical structure, . . . ).

Depending on the target position, the length of the transition fibers and the thickness of the transition fibers can vary as desired, also within a fiber array element. The length of the transition fibers is typically a few 100 μm to a few 10 mm. The transition fiber typically consists of core and sheath, but can also be designed, for example, in a core-less variant. The transition fiber can also be tapered. A Cladding Light Stripper can be introduced before and in the transition fiber. The transition fiber can be used, for example, for influencing the optical properties, such as the beam quality, the polarization, the optical power stability and for beam-forming, in the fiber array.

An exemplary embodiment and further advantages of the invention are illustrated in a purely schematic manner and in detail below in connection with the following figures. In particular:

FIG. 1a shows a schematic representation of a longitudinal section of a fiber exit element according to the invention according to a first exemplary embodiment from the side;

FIG. 1b shows a perspective view of the view of FIG. 1a obliquely from above;

FIG. 1c is a perspective view of a fiber outlet element according to the invention according to a second embodiment from obliquely above;

FIG. 1d is a perspective view of a fiber outlet element according to the invention according to a third embodiment from obliquely above;

FIG. 2a is a schematic view of a longitudinal section of a fiber outlet element according to the invention according to a fourth embodiment from the side;

FIG. 2b is a schematic view of a longitudinal section of a fiber exit element according to the invention according to a fifth embodiment from the side;

FIG. 3 shows a schematic representation of a longitudinal section of a fiber exit element according to the invention according to a sixth exemplary embodiment from the side;

FIG. 4 shows a schematic representation of a longitudinal section of a fiber exit element according to the invention according to a seventh embodiment from the side;

FIG. 5a schematic representation of a longitudinal section of a fiber exit element according to the invention according to an eighth embodiment from the side; and

FIG. 5b shows a schematic representation of a longitudinal section of a fiber exit element according to the invention according to a ninth embodiment from the side.

The above figures are considered in Cartesian coordinates. A longitudinal direction X is shown, which can also be referred to as depth X or as length X. A transverse direction Y, which can also be referred to as width Y, extends perpendicular to the longitudinal direction X. A vertical direction Z, which can also be referred to as height Z, extends perpendicular both to the longitudinal direction X and to the transverse direction Y. The longitudinal direction X and the transverse direction Y together form the horizontal X, Y, which can also be referred to as horizontal plane X, Y.

FIG. 1a shows a schematic representation of a longitudinal section of a fiber exit element 1, 2 according to the invention according to a first exemplary embodiment from the side. FIG. 1b shows a perspective view of the view of FIG. 1a obliquely from above. The fiber exit element 1, 2 can also be referred to as a signal light radiation output 1, 2, as fiber exit optics 1, 2 or as fiber array 1, 2.

The fiber outlet element 1, 2 has a plurality of glass fibers 1, each of which has a core 10, which is surrounded by a coating 12 in each case by a sheath 11 and the sheath 11. The cross sections or the contours of the cores the jackets 11 and the coatings 12 are each circular. In its longitudinal direction of extension, the glass fibers 1 end in the vertical direction Z at a common same height, each with an open end (not denoted). In this case, the cores 10 and the jackets 11 of the glass fibers 1 extend equally far and end together at the respective open end. The coatings 12 are each spaced apart in the vertical direction Z at the same height to the open ends of the glass fibers 1.

The fiber exit Element 1, 2 further comprises an optical Element 2, which can also be referred to as an optical window 2, as an optical lens 2, as an optical beam splitter 2, as an optical prism 2 or an optical lens array 2. An optical main body 20 of the optical element 2 in the form of a glass body 20 is, for example, cuboid in accordance with FIG. 1b and has an entry surface 21 pointing upward in the vertical direction Z and an exit surface 24 facing downwards. The four sides of the cuboid optical element 2 are formed by the side surfaces 25. An optical coating 26 in the form of An Anti-reflection coating 26, which can be assigned to the optical Element 2, is applied to the underside of the optical Element 2, so that the exit surface 24 of the optical Element 2 coincides with the underside or outer side of the Anti-reflection coating 26.

The side surfaces 25 and the entry surface 21 of the optical Element 2 are optically roughened in this case in order to promote the escape of interference radiation from the optical Element 2. The underside or the exit surface 24 of the optical element 2, which is covered by the optical coating 26, is optically smooth in order thereby to promote the exit of the exit radiations.

In the region in which the coatings 12 are removed, the jackets 11 of the glass fibers 1 each have a pump light trap (not shown), which can also be referred to as cladding layer or as a Stripping Element and is designed in the form of annular depressions. As A result of the orientation of the annular depressions perpendicular to the propagation direction of the signal light beams A or the longitudinal direction of extension of the glass fibers 1, a disruptive cladding light can be coupled out to the outside directly before reaching the optical element 2 from the men 11 of the glass fibers 1. In this way, the entry of interference radiation on the part of the cladding light into the optical Element 2 can be avoided. Return cladding light, coming from the optical Element, can also be reduced.

The open ends of the cores 10 and of the jackets 11 of the glass fibers 1 are arranged with a penetration depth W relative to the entry surface 21 of the optical element 2 within the material of the optical element 2. For this purpose, the materials of the cores 10 and of the jackets 11 of the glass fibers 1 have been fused with the material of the optical element 2, as will be described in more detail further below. This can ensure that signal light beams A can be introduced as interference-free and completely into optical Element 2, for example in the form of laser light beams A. The signal light beams A introduced into the optical Element 2 can pass through this and exit the exit surface 24 of the optical Element 2 to the outside as exit radiations (not shown). The exit radiations can thereby also form a combined output beam. In this way, the mechanical stability of the cohesive connection between the glass fibers 1 and the optical Element 2 can also be improved.

The production of a fiber exit element 1, 2 according to the invention can take place in such a way that individual glass fibers 1 are fused successively individually or grouped in the material of the entry surface 21 of the optical element 2 or its optical body 20. This can be done, for example, by the fact that a laser radiation is directed to a location or to a region of the entry surface 21 of the optical element 2 in order to adequately heat this location or this region as a processing zone, so that the open ends of the glass fibers 1 can be inserted or pressed into the melted material of the entry surface 21 of the optical element 2 and can thus be joined to fuse with the material of the entry surface 21 of the optical element 2.

For example, a processing zone of the entrance surface 21 of the optical element 2 may be heated as described above to receive and fuse the open end of a first glass fiber 1a of the glass fibers 1. Now, immediately next to the already fused first glass fiber 1a with a fiber-to-fiber distance L F a second glass fiber 1b of the glass fibers 1 is fused in its processing zone, the heat of the processing zone of the second glass fiber 1b can extend to the already fused first glass fiber 1a. Thus, sufficient heat can be transferred from the material of the entry surface 21 of the optical element 2 to the already fused first glass fiber 1a, which can lead to damage or destruction of the already fused first glass fiber 1a. In particular, this can prevent a compact arrangement of glass fibers 1 or at least sufficiently large fiber-to-fiber distances L F between the individual glass fibers 1, if the glass fibers 1 are to be fused in succession.

According to the invention, the optical Element 2 therefore has recesses 22 of its entry surface 21, which are introduced in line form by material removal between the individual processing zones of the glass fibers 1 into the material of the optical body 20 from the entry surface 21. This can be done, for example, by sawing, milling, etching and the like. The recesses 22 here have a width B_{V}, a length L_{V} and a depth T_{V} on. Width B_{V} the depressions 22 can preferably be selected to be as small as possible in order to minimize the installation space of the fused glass fibers 1. The length L_{V} the depressions 22 can be selected as much as possible in such a way that the desired thermal decoupling in the horizontal X, y is achieved without having to introduce the depressions 22 in the vertical direction Z unnecessarily far into the optical body 20.

In this way, according to the invention, the propagation of the heat from the processing zone of the second glass fiber 1b to be fused to the previously fused first glass fiber 1a can be sufficiently prevented by a first depression 22a of the depressions 22 in order to avoid damage to the fused first glass fiber 1a. This can accordingly be achieved by a second depression 22b of the depressions 22 for the second glass fiber 1b that is then fused.

FIG. 1c shows a perspective view of a fiber exit element 1, 2 according to the invention according to a second embodiment from obliquely above. In this case, the depressions 22 are introduced in a cross-linear manner into the entry surface 21 of the optical element 2, so that the individual glass fibers 1 in the horizontal X, y are spaced apart from one another in all directions and thus thermally insulated.

FIG. 1d shows a perspective view of a fiber exit element 1, 2 according to the invention according to a third exemplary embodiment obliquely from above. The idea according to the invention of the thermal insulation of glass fibers 1 previously melting in succession can thus also be implemented by applying a plurality of elevations 23 to the entry surface 21 of the optical element 2 or its optical body 20 by material application. The elevations 23 each have a length L_{E}, a width BE and a depth T_{E} on. In this case too, the dimensions of the elevations 23 in the horizontal X, y, i.e. the width BE and the depth T_{E} preferably as small as possible in order to minimize the installation space of the fused glass fibers 1. The length L_{E} the elevations 23 can also be selected as much as possible in such a way that the desired thermal decoupling in the horizontal X, y is achieved without the elevations 23 in the vertical direction Z being unnecessarily projecting upward from the entry surface 21 of the optical body 20.

In the material of the elevations 23, which can be attributed to the entry surface 21, the glass fibers 1 can now be fused individually or grouped In succession as described above. For example, a first glass fiber 1a of the glass fibers 1 can be fused into the material of a first elevation 23a of the elevations 23. Subsequently, a second glass fiber 1b of the glass fibers 1 can be fused into the material of a second elevation 23b of the elevations 23, without the previously fused first glass fiber 1a being thermally achieved.

FIG. 2a shows a schematic representation of a cross section of a fiber exit element 1, 2 according to the invention according to a fourth exemplary embodiment from the side which is designed comparable to the fiber exit element 1, 2 according to the first exemplary embodiment of FIGS. 1a and 1b. In this case, there is the difference that in this case the entry surface 21 of the optical element 2 is curved. The glass fibers 1 are oriented in the vertical direction Z and parallel to one another.

FIG. 2b is a schematic view of a cross section of a fiber exit element 1, 2 according to the invention according to a fifth embodiment from the side. The fifth exemplary embodiment of FIG. 2b is also designed comparable to the fiber exit element 1, 2 according to the first exemplary embodiment of FIGS. 1a and 1 b. Here, the difference is that the two sections of the entry surface 21 of the optical element 2, which each accommodate the glass fibers 1 perpendicularly, are oriented inclined relative to the horizontal X, y and thus also in relation to the exit surface 24 of the optical element 2.

FIG. 3 is a schematic view of a cross section of a fiber exit element 1, 2 according to the invention according to a sixth embodiment from the side. The sixth exemplary embodiment of FIG. 3 corresponds to the first exemplary embodiment of FIGS. 1a and 1 b with the difference that instead of the optical coating 26 of the exit surface 24 the exit surface 24 is designed as optical elements 27 in the form of lenses 27, each of which is assigned to one of the glass fibers 1.

FIG. 4 is a schematic view of a cross section of a fiber exit element 1, 2 according to the invention according to a seventh embodiment from the side. In this case, several spacer elements 13, which can be portions or pieces of glass fibers, are placed laterally between the glass fibers 1 In the region exposed by the coatings 12 In order to space the glass fibers 1 from one another. In this configuration, the glass fibers 1 are jointly fused together with the material of the entry surface 21 or of the optical body 20 of the optical element 2 Via a correspondingly large or elongate processing zone. The positioning and the spacing of the glass fibers 1 can be precisely carried out by the support elements 13 and also maintained during the joining process.

FIG. 5a shows a schematic representation of a cross section of a fiber exit element 1, 2 according to the invention according to an eighth exemplary embodiment from the side. In this case, transition fibers 14, each having a core 14a and a jacket 14b, are attached in advance to the open ends of the glass fibers 1. The transition fibers 14 here have a thickness D_{U} and a length L_{U} on. Thickness D_{U} or the cross section of the transition fibers 14 corresponds to the thickness or the cross section of the glass fibers 1. The length L_{U} the transition fibers 14 are selected to be sufficiently long in order to be able to reliably handle the transition fibers 14 during joining with the glass fibers 1, on the other hand short enough to obtain a compact structure.

The joining of the transition fibers 14 of the glass fibers 1 at connection points C can be accomplished by bonding or by fusing. The connection points C formed here can also be referred to as welding points C or as splicing sites C. Subsequently, the transition fibers 14 together with glass fibers 1 can be fused successively to the optical body 20 or its entry surface 21 as described above.

FIG. 5b shows a schematic representation of a cross section of a fiber exit element 1, 2 according to the invention according to a ninth embodiment from the side. In this case, the thickness D is u or the cross section of the transition fibers 14 is selected such that the individual transition fibers 14 touch one another or rest against one another, so that the transition fibers 14 can simultaneously act as spacer elements 13 as described with reference to the seventh exemplary embodiment of FIG. 4.

List of reference numerals (part of the description)
A Signal light beams, laser light beams
C Connection sites; welds
W Penetration depth
L_{F} Fiber-to-fiber distance; distance between two directly adjacent glass fibers 1 or cores 10 of glass fibers 1
B_{V} Width of the depressions 22 in the transverse direction Y
L_{V} Length of the depressions 22 in the vertical direction Z
T_{V} Depth of the recesses 22 in the longitudinal direction X
L_{E} Length of the elevations 23 in the vertical direction Z
B_{E} Width of the elevations 23 in the transverse direction Y
T_{E} Depth of the elevations 23 in the longitudinal direction X
D_{U} Thickness or diameter of the transition fibers 15
L_{U} Length of the transition fibers 15 in the vertical direction Z
X X Longitudinal direction; depth; length
Y Y Transverse direction; width
Z vertical direction; height
X, Y X, Y Horizontal, horizontal plane
1, 2 Fiber exit element; signal light radiation output, fiber exit optics; fiber array
1 Glass fibers
1a First glass fiber of glass fibers 1
b second glass fiber of glass fibers 1
10 Cores of glass fibers 1
11 Jackets of glass fibers 1
12 Coatings of the Glass Fiber 1
13 Spacer elements
14 Transition elements; transition fibers
14a Cores of the transition fibers 14
14b Male transition fibers 14
2. Optical Element; Optical window; optical lens, optical beam-splitter; optical prism, optical lens array optical body; glass body
21 Entry surface of the optical element 2
22 Depressions of the entry surface 21
22a first depression of the entry surface 21
22b second depression of the entry surface 21
23 Elevations or webs of the entry surface 21
23a first elevation of the entry surface 21
23b second elevation of the entry surface 21
24 Exit surface of the optical element 2
25 Side surfaces of the optical element 2
26 optical coating of the exit surface 24; Anti-reflection coating
27 optical elements or lenses of the exit surface 24

1. A fiber exit element
with a plurality of glass fibers each having at least one core, each of which is designed to guide a signal light radiation, and
with at least one optical Element, an optical lens, an optical beam splitter, an optical prism or an optical lens array, which is connected and formed with an open end of the cores of the glass fibers in each case and is designed to obtain the signal light radiation from the open ends of the cores of the glass fibers and to discharge them to the outside as exit radiation via at least one exit surface,
wherein the open ends of the cores of the glass fibers, are arranged with a penetration depth opposite an entry surface of the optical element within the material of the optical element, and
wherein at least the material of the open ends of the cores of the glass fibers is fused to the material of the optical element,
characterized in that
the entrance surface of the optical element has at least one first depression, and
at least one first fused glass fiber and a second fused glass fiber are spaced apart by the first depression of the entry surface.

2. A fiber exit element according to claim 1,
wherein the first depression of the entry surface is linear and
wherein the fused glass fibers are arranged perpendicular to the linear extension of the first depression of the entry surface.

3. A fiber exit element according to claim 1,
wherein at least the first fused glass fiber is enclosed by the first cavity or by a plurality of preferably cross-linear recesses.

4. A fiber exit element according to claim 1,
wherein the entry surface of the optical element has a plurality of, preferably linear, depressions and
wherein a plurality of fused glass fibers are each spaced apart from one another by one of the depressions of the entry surface,
wherein the fused glass fibers are each arranged perpendicular to the linear extension of the depressions of the entry surface and/or
wherein the fused glass fibers are preferably each enclosed by one of the depressions or by a plurality of, preferably cross-linear, depressions.

5. A fiber exit element according to claim 1,
wherein the first depression of the entry surface is annularly arranged around the first fused glass fiber.

6. A fiber exit element
with a plurality of glass fibers each having at least one core, each of which is designed to guide a signal light radiation, and
with at least one optical Element, an optical lens, an optical beam splitter, an optical prism or an optical lens array, which is connected and formed with an open end of the cores of the glass fibers in each case and is designed to obtain the signal light radiation from the open ends of the cores of the glass fibers and to discharge them to the outside as exit radiation via at least one exit surface,
wherein the open ends of the cores of the glass fibers are arranged with a penetration depth opposite an entry surface of the optical element, within the material of the optical element, and
wherein at least the material of the open ends of the cores of the glass fibers, is fused to the material of the optical element (2),
characterized in that
the entry surface of the optical element has at least one first elevation,
wherein at least one first fused glass fiber is disposed in the first elevation of the entry surface, and
wherein at least one second fused glass fiber is not arranged in the first elevation of the entry surface of the first optical fiber.

7. A fiber exit element according to claim 5,
wherein the second fused glass fiber is arranged in a second elevation of the entry surface.

8. A fiber exit element according to claim 5,
the first elevation of the entry surface being linear or punctiform.

9. A fiber exit element
with a plurality of glass fibers each having at least one core, each of which is designed to guide a signal light radiation, and
with at least one optical Element, an optical lens, an optical beam splitter, an optical prism or an optical lens array, which is connected and formed with an open end of the cores of the glass fibers in each case and is designed to obtain the signal light radiation from the open ends of the cores of the glass fibers and to discharge them to the outside as exit radiation via at least one exit surface,
wherein the open ends of the cores of the glass fibers are arranged with a penetration depth opposite an entry surface of the optical element, within the material of the optical element, and
wherein at least the material of the open ends of the cores of the glass fibers, is fused to the material of the optical element,
characterized in that
at least one first fused glass fiber and a second fused glass fiber are spaced apart from one another by at least one spacer element.

10. A fiber exit element
with a plurality of glass fibers each having at least one core, each of which is designed to guide a signal light radiation, and
with at least one optical Element, an optical lens, an optical beam splitter, an optical prism or an optical lens array, which is connected and formed with an open end of the cores of the glass fibers in each case and is designed to obtain the signal light radiation from the open ends of the cores of the glass fibers and to discharge them to the outside as exit radiation via at least one exit surface,
characterized in that
the open ends of the cores of the glass fibers are each integrally bonded to a first open end of a transition element,
wherein the second open ends of the transition Elements are each arranged with a penetration depth within the material of the optical element, and
wherein at least the material of the second open ends of the transition Elements is fused to the material of the optical element,
wherein the transition elements are preferably transition fibers which each have a core and/or a sheath which substantially surrounds the core.

11. A fiber exit element according to claim 9,
wherein the transition elements are formed, at least in sections, preferably completely, wider than the glass fibers,
wherein preferably the transition elements rest against each other at least in sections, preferably completely.

12. A fiber exit element according to claim 1,
wherein the entry surface is arranged at an angle to the exit surface and/or
wherein the entry surface has at least two sections which are arranged at an angle to one another and/or to the exit surface.

13. A fiber exit element according to claim 1,
wherein the exit surface of the optical element has an optical coating at least in sections.

14. A fiber exit element according to claim 1,
wherein at least one of the glass fibers has at least one sheath which substantially encloses the core,
wherein at least one pump light trap is formed in the material of the sheath of the glass fiber in the region of the fiber outlet element in order to discharge cladding light from the sheath of the glass fiber outside the glass fiber.

15. An optical element for use in a fiber exit element according to claim 1.
